(19) United States
(12) Patent Application Publication
(10) Pub. No.: US 2005/0014488 A1
(43) Pub. Date: Jan. 20, 2005

(54) Process for producing background sound recordings for voice mail systems

(76) Inventor: James M. Baker, Hilton Head Island, SC (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/621,841

(22) Filed: Jul. 17, 2003

(51) Int. Cl. H04M 11/10

(52) U.S. Cl. 455/413

(57) ABSTRACT

A process for use by a non-professional to record a greeting or message for a voice mail system. A CD is placed in a CD player, or an Internet website is accessed. Recorded on the CD or the website are multiple segment tracks with each segment containing background music or a sound effect. At the beginning of each segment is a distinctive, audible note which is used to synchronize the background music or sound effect with the beginning of a recording. A menu for the voice mail system for recording messages is accessed to find a prompt for starting a recording. The CD player or website is enabled to play the track while a user records a greeting or message. The background music or sound effects are recorded together with the speaker's voice so both are simultaneously recorded in the voice mail system. The background music or sound effect is now heard whenever the greeting or message is replayed.

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention relates to voice mail used by individuals or businesses; and more particularly, the generation of background sounds or music for voice mail including a process by which non-professionals can generate the background played on their voice system systems.

Automated call directing or ACD systems are widely used, particularly by businesses. They typically provide greetings or announcements to project a certain image of the business and to create a desired mood for callers. This is accomplished by mixing voice with sound effects and/or music to create a background for while a caller is waiting on line to speak to someone, wait for a menu of choices provided by the telephone system, etc.

Heretofore, businesses (and to a lesser extent individuals) have had to rely on professional services to create the desired background effects. Recording studios, for example, have the capability to create recordings which mix voice and background music for greetings and/or announcements on an ACD system. The processes used by the studios are expensive and required trained, skilled personnel to operate. Consequently, the cost of producing mixed recordings is normally affordable only by large companies.

Voice mail (VM) systems can be considered scaled down versions of ACD systems and are commonly used by smaller businesses and individuals. The ability of small businesses to have a VM system with the same features as described above for an ACD system can be an effective and valuable tool, depending on the type of business, in stimulating commerce. The problem, however, is to provide the desirable background features in a convenient and affordable way. The Synchrosound™ recording system of the present invention is for use by businesses, other organizations, and individuals to produce enhanced VM greetings and announcements for the phone system used by the individual or business entity.

In ACD and VM systems, a major problem is the timing and synchronization of a speaker's voice with the accompanying background music or special effects. Specifically, the problem is that these systems require a user to commence the recording immediately at a cue given by the system. With a VM system, for example, this would be a cue such as “Record a greeting for your callers.” While the cue works fine for simple, voice only greetings and announcements, it is not sufficient for creating a recording that is a mix of both voice and music or special effects. In this situation, the user of the accompanying sound player must trigger the start of the accompanying sound so that it commences immediately. A second problem is to fit the length of the music or special effect, whatever they may be, to the speaker's greeting.

### BRIEF SUMMARY OF THE INVENTION

This present invention is directed to a process for creating a structured recording on a compact disk (CD) or other commonly available recording media such as those used in cassette tape players. The structured recording makes it convenient, easy, and affordable for an individual or small business to inexpensively produce professional sounding, synchronized voice mail greetings and announcements using only a CD player. The unique structure of the recording also supports the creation of voice greetings and announcements of widely varying duration. The process readily mixes a voice with background music and the sound effects, and synchronizes the music and sound effects with the voice to provide a smooth, professional sounding result. It does this through use of a multi-segment structure which enables the user to easily place an ending music or special effect segment with the end of the speaker's voice.

The process of the invention not only makes it convenient and easy for non-professionals to create professional sounding recordings for a voice mail system, but to also conveniently and easily change the background, the greeting, or the announcement. Because of the convenience and ease with which changes can be made, the voice mail can be frequently changed and be kept “fresh” and creative.

Other objects and features will be in part apparent and in part pointed out hereinafter.

### BRIEF DESCRIPTION OF THE SEVERAL VIEWS OF THE DRAWINGS

The sole FIGURE of the drawings is one showing a timing sequence used by the process of the invention to add background sounds to a voice recording in a synchronized manner.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

The process of the present invention is for recording a background track on a CD or the like. The CD is then played when someone is making a voice mail greeting or announcement. Persons would use recordings made with this process to make voice mail greetings/announcements that have the music or sound effects on the recording as background or embellishment to their voice. The process allows for a large selection of music and special effects to be used so that voice mail greetings can be readily customized for the user. In operation, the process synchronizes the start of the body of the background (music or special effects, or both) with respect to the start of a voice mail recording process and the users speech.

The process accomplishes this by first starting a recording with a note used to synchronize the playing of the background with the voice recording. First, the note can be a tone outside of the bandwidth of that of the voice mail system; yet which is audible to a person having normal hearing. This is usually a low frequency or low tone. The purpose of the tone is to synchronize the background with the recorded greeting or message. The tone provides a cue to the user to pause the play of the CD. This allows time for the user to set up the voice mail system to record a greeting or announcement. Typically, this is done by pressing a sequence of buttons on a phone set. The out of band frequency of the tone is advantageous in that if the CD player does not have a pause feature, the cue tone will not register on the voice mail recording. Second, it has also been found that the note which is a distinctive, low volume tone, within the bandwidth of the voice mail system, can also be used to synchronize the background with the greeting or message. Third, it has further been found that besides a tone (which is of uniform frequency throughout its duration), the note can be a more complex sound. The requirements for the sound are that it be distinctive enough that the user can recognize it, and that it be of a sufficiently low volume as to not be recorded as part of the background.

Next, the body of the background music or sound effects is recorded. At the end of the recording, the user can record another note to indicate completion. This, however, is optional. After the second note is recorded, several seconds of silence is recorded. This is done to prevent any subsequent recording on the CD which might start or intrude on the intended track before the user pauses play. Those skilled in the art will understand that because the pause cue note is a low tone or sound, inadvertent recording of it will not register on the ultimate mixed recording. Use of a note as described above makes structured recordings using this invention applicable to music players that do not have “pause” controls (as is commonly the case in car stereos).

To make a voice mail greeting which mixes voice with a background recording, the user will need a CD player, the CD on which the background is recorded as described above, and a telephone. The telephone can be either a conventional (wired) phone or a portable (wireless) one. The CD on which the background is recorded has several tracks, just like a typical music CD. Each background track on the CD track has one or more sound segments of music or a special effect. These are each separated by a distinctive, low volume note to aid in cueing the timing of play. By providing tracks with multiple sound segments, the user will have a great deal of flexibility so they can be as creative as they want to be in recording their voice mail greetings and announcements.

The CD player's controls should be convenient for the user to operate. Preferably the CD player has a “pause” control; although the process can be used with a CD player not having such a control. In setting up the CD player, it is recommended that the volume be adjusted so the user is able to hear the CD player playing as loudly as someone talking fairly loudly. Since the user's voice will dominate the resulting recording, the music will not necessarily be too loud.

To make a recording, the user positions himself and arranges the speaker of a CD player so the sound output of the speaker register on the telephone handset's integral microphone, when the user speaks into the microphone. Actual signal mixing is performed incidentally by the handset's microphone as the sound of the user's voice and the sound from the CD player's speaker impinge on it. The distance of the speakers is of no importance since volume can be controlled; although the volume of play can be adjusted. This may be done after assessing the results of a mixed recording attempt.

The user now starts playing the recordings on the CD, selects a desired track, and pauses the play at the pause cue note preceding the background segment desired. While play is paused, the user accesses the voice mail system's utility menu for recording a greeting or announcement. When the voice mail system prompts the user to start recording his greeting or announcement, the user presses the pause release control on the CD player. Play of the desired background music or sound effect now begins. In accordance with the present invention, the user can start the background segment prior to beginning his voice recording so to provide an “introduction” to it, synchronized with the start of, or after voice recording has started. The user now starts speaking the greeting or message and the background is recorded simultaneously with the speaker's voice. Importantly, the recorded message and the background are synchronized with each other. If the spoken part is longer than the background track, the user pauses the CD player when he hears the second low note that designates the end of the background segment. This prevents the sounds from subsequent tracks from interfering with the recording.

The user can do the same thing at the end of the voice recording to close out the greeting or announcement. If the user has finished talking and the background is still playing, the user gradually turns the volume down before stopping play to produce a “fade out” effect. In any event, at the end of the background segment, there is another pause cue note which tells the user to stop the player before the next background segment on that track or before the next track begins.

The background tracks include several seconds of silence at their end to facilitate use of the process with non-pause-equipped CD players. While the background recordings work best with players having a pause control, they can also be used with non-paused-equipped players. When used with this type of CD player, the portion of silence at the end of the segment allows the user to stop play by turning the player off (yet have a safe margin of time such that, when it is restarted, the user has time to press the “back” control before the track ends) and get the voice mail system to the point where recording can start. Recording commences when the user presses the “back” control on the CD player to restart the current track on the player. That is, the segment is played from the beginning. When used this way, the transparency of the initial low volume note to telephone systems is a nice feature.

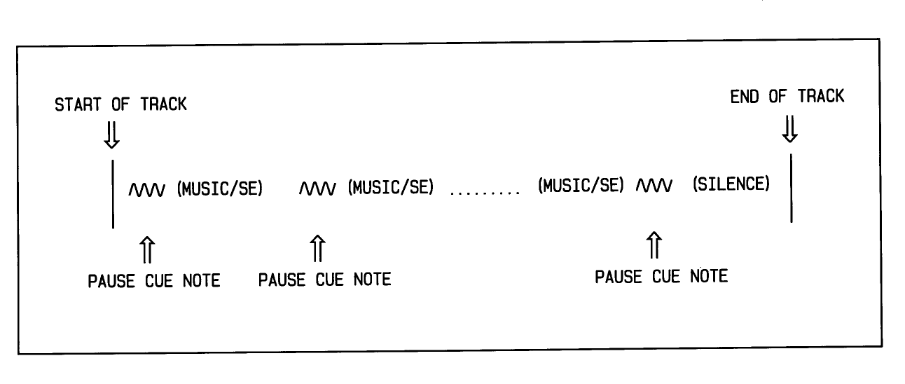

The above sequence of process steps is shown in FIG. 1. There, the recorded track is shown to include segments of music or special effects SE recorded as background for the recorded greetings or messages. The pause cue notes are used to tell the user when to pause. Similarly with respect to FIG. 1, some background tracks contain a series of music or sound effect segments and these segments can be used at various points in the recording. Thus, for example, the recorded track may have a brief music segment at the beginning of a greeting, this segment serving as an introduction. A second segment is then used at the end of the greeting. The two background segments are separated by a low volume note. In making the recording, the user will pause the CD player at the pause note following the first segment, complete the greeting, and then release the pause button on the CD player to record the ending background segment.

It is a feature of the invention that the background segments and the attendant mixing approaches can be used in numerous ways and that there are essentially no limitations on their use. For example, one track may have just one music or sound effect segment, and can serve as the background for the entire mixed recording. It could also serve as an “introduction” such that the voice commences during it or immediately after it. A two segment track, on the other hand, can include both an introduction and an ending. Those skilled in the art will understand that there are many possible combinations of multiple segments.

While it is easier to make a recording with a CD player having a pause control, a recording for use on a voice mail system can be made even if the player does not have a pause control. In such instance, it is preferable to use a background track having only a single music or sound effect segment.

Now, the user selects the track they want to use as background. They then play the track until they hear the low volume note at the end of the background segment. At that time, they stop or turn-off the CD player. This provides the user time to get into the voice mail system and prepare it to accept a new greeting. Again, the user goes to the utility menu of the voice mail system and selects the option that allows the greeting to be changed. The user then goes through the menu to the point where it tells he is instructed to start recording the greeting. Then, once the user is in the recording mode and ready to start the background music or sound effects playing, he turns the CD player back on and presses the “back” control on the player to return to the beginning of the background track. This starts the play at the beginning of the track. After the ending cue note on the track there will be a few seconds of silence which gives the user time to stop the player again. When the player is again restarted (as described above), the user will have time, with a reasonable margin of safety, to press the “back” control and again return to the beginning of the track.

It is an important feature of the invention to have the background music or sound effects fit the length, whatever that is, of the speaker's greeting or message. With the multi-segment background structure, the user can easily record an ending music segment which is placed so that it is synchronized with the end of the recorded greeting or message.

In general, the structure of the background recording is embodied primarily on CD's, but could be on other media. The accompaniment/background recording comprises a number of structured tracks with individual material recorded on both left and right stereo channels. Each track starts with a brief, low frequency pause cue note which is immediately followed by the accompaniment/background music or sound effects. The background tracks can have more than one segment with the pause cue note terminating one segment providing the cue for use in synchronizing the start of the subsequent track. If the segment is the last segment on the track, the cue tone signifies the end of the track and the user should stop play before play proceeds to the next track.

Those skilled in the art will appreciate that background recordings can now also be made by downloading a music segment or background sound effect from the internet or by playing music or sound effects from an audio clip selected from a web page, which selection and playing is typically done by clicking a button on the web page. The process is similar to that described above in that a website, rather than a CD has segments of music and sound effects recorded on it. For the case of downloading from a web site, appropriate notes used for synchronizing the download with the voice mail system greeting or message are incorporated on the segments. When the user wants to record his message with the background from an audio clip from a web page, he configures his voice mail system as described above. The actual recording then proceeds as described above. Since the playing of the background can be commenced instantly by clicking on an object (such as a button) on a web page, there is no need for pause cue notes in the case using the web page interactively.

In view of the above, it will be seen that the several objects and advantages of the present invention have been achieved and other advantageous results have been obtained.

1. A process for recording a greeting or message for a voice mail system comprising:
placing a CD on which is recorded at least one track of background music or sound effects into a CD player;
accessing a menu on the voice mail system for recording messages and proceeding through the menu to a prompt for starting a recording; and,
enabling the CD player to play the track while a user records the greeting or message, the background music or sound effects being recorded together with the speaker's voice so that both are simultaneously recorded in the voice mail system, the background music or sound effect being subsequently heard whenever the greeting or message is replayed.

2. The process of claim 1 further including formatting the CD with multiple track segments each of which includes background music or a sound effect that can be used as background for the recording.

3. The process of claim 1 further including placing an audible, distinctive note at the beginning of the track, the note being used to synchronize the background music or sound effect with the beginning of the recording.

4. The process of claim 3 in which the tone is an audible note which can be one of i) a frequency outside the bandwidth of the voice mail system, or ii) a frequency inside the bandwidth of the voice mail system, or iii) a complex sound.

5. The process of claim 3 further including placing an audible note at the end of the track, the note being used to synchronize the background music or sound effect with the end of the recording.

6. The process of claim 5 in which the CD includes multiple tracks each having multiple segments.

7. The process of claim 3 further including playing the CD until the audible note is heard and then pausing play of the CD until the user is ready to record.

8. The process of claim 7 further including recommencing play of the CD when the user begins recording the greeting or message.

9. The process of claim 8 further including continuing play of the CD throughout the recording interval so there is a continuous background throughout the greeting or message.

10. The process of claim 8 further including stopping play of the CD prior to the beginning of the greeting or message so the background serves as an introduction to the greeting or message.

11. A process for recording a greeting or message for a voice mail system comprising:
accessing an internet website on which is recorded at least one track or audio clip of background music or sound effects and selecting an audio clip to be recorded on the voice mail system;
accessing a menu on the voice mail system for recording messages and proceeding through the menu to a prompt for starting a recording; and,
enabling play of the selected audio clip from the website while a user records the greeting or message on the voice mail system, the background music or sound effects being recorded together with the speaker's voice so that both are simultaneously recorded on the voice mail system, the background music or sound effect being synchronized with the greeting or message.

12. A process for recording a greeting or message for a voice mail system comprising:
placing a CD on which is recorded at least one track of background music or sound effects into a CD player; and,
enabling the CD player to play the track while a user records the greeting or message on the voice mail system, the background music or sound effects being recorded together with the speaker's voice so that both are simultaneously recorded on the voice mail system, the background music or sound effect being synchronized with the greeting or message.

13. The process of claim 12 further including placing an audible, distinctive note at the beginning of the track, the note being used to synchronize the background music or sound effect with the beginning of the recording.

14. The process of claim 13 further including placing an audible note at the end of the track, the note being used to synchronize the background music or sound effect with the end of the recording.

15. The process of claim 12 further including stopping play of the CD prior to the beginning of the greeting or message so the music or sound effects serves as an introduction to the greeting or message.

16. The process of claim 15 further including continuing play of the CD throughout the recording interval so there is a continuous background throughout the greeting or message.

17. A CD for use in for recording a greeting or message for a voice mail system comprising:
a disc on which is recorded at least one track of background music or special effects, the disc being played together with the recording of a voice speaking a greeting or message so they are simultaneously recorded; and,
an audible note at the beginning of the track used to synchronize the background music or sound effect with the beginning of the recording.

18. The CD of claim 17 having multiple track segments each of which includes background music or a sound effect that can be used as background for the recording.

19. The CD of claim 18 further including an audible note at the end of the track, the note being used to synchronize the background music or sound effect with the end of the recording.

20. The CD of claim 17 which is a stereo disk.
